(19) United States
(12) Patent Application Publication
(10) Pub. No.: US 2026/0276151 A1
(43) Pub. Date: Sep. 17, 2026

(54) CRYOGENIC SUB-COOLING

(71) Applicant: UNIVERSITEIT TWENTE, Enschede (NL)

(72) Inventors: Srinivas VANAPALLI, Enschede (NL); Herman Johannes HOLLAND, Enschede (NL)

(73) Assignee: UNIVERSITEIT TWENTE, Enschede (NL)

(21) Appl. No.: 18/873,818

(22) PCT Filed: Jun. 15, 2023
(86) PCT No.: PCT/NL2023/050334

§ 371 Date: Dec. 11, 2024

(30) Foreign Application Priority Data
Jun. 16, 2022 (NL) 2032192

(51) Int. Cl. F17C 9/02

(52) U.S. Cl. CPC F17C 9/02; F17C 2223/0161; F17C 2225/0123; F17C 2227/0135

(57) ABSTRACT

The invention provides a method for subcooling a cryogenic liquid (1), the method comprising providing a discharge element (2) comprising a first discharge element portion (23) comprising (i) a discharge element inlet opening (21), (ii) a throttle element (25), and (iii) a heat conductive wall (28); providing a cryogenic liquid (1) in an open container (10); immersing the first discharge element portion (23) in the cryogenic liquid (1) in the open container (10); and reducing a pressure in the discharge element (20) at a downstream side (26) of the throttle element (25), thereby inducing a flow of the cryogenic liquid (1) from an upstream side (24) of the throttle element (25) through the throttle element (25), wherein at least part of the cryogenic liquid (1) changes phase at the downstream side (26) of the throttle element (25), thereby providing a heat flow from the cryogenic liquid (1) surrounding the discharge element (20) to the first discharge element portion (23).

### FIELD OF THE INVENTION

The invention relates to a system and a method for subcooling a volatile fluid.

### BACKGROUND OF THE INVENTION

Several ways to subcool volatile fluids are known in the art. U.S. Pat. No. 539,608, for instance describes a method and apparatus for subcooling a liquid composed of a volatile fluid, for instance, a saturated liquid cryogen, in which two chambers are filled with the fluid and are each initially pressurized after filling so that the fluid is converted to a subcooled liquid. The pressurization of the two chambers is maintained as the subcooled liquid is delivered from each of the two chambers. The filling and the delivery of the two chambers is affected in accordance with a cycle in which one chamber is filled and initially pressurized just prior to the completion of the delivery from the other chamber to allow the continual delivery of the subcooled liquid.

Further, CN108386708 B describes a pressure controlled low temperature storage tank with a jetting device. The pressure controlled low temperature storage tank consists of a tank body, a low temperature circulating pump, a liquid throttle valve, a heat exchanger, a fluid ejector and an exhaust cooling system. The heat exchanger comprises a first heat exchange path and a second heat exchange path in countercurrent arrangement, the tank body, the low temperature circulating pump, the first heat exchange path and the fluid ejector are communicated with each other in order to form a large stream fluid circulation loop, the tank body, and the liquid throttle valve, the second heat exchange path and the exhaust cooling system are communicated with each other in order to form a throttling refrigeration route. The fluid ejector is arranged in the tank body, and the fluid ejector is provided with jet orifices at least in the upper space inside the tank body. The exhaust cooling system includes an ejector, an orthohydrogen-parahydrogen conversion device and an exhaust cooling coil. The pressure controlled low temperature storage tank provided by the invention has the advantages of simple structure, large jet intensity, and good heat exchange efficiency, can effectively eliminate heat leakage of the tank body, and realize good control of the tank pressure, and has good application value and popularization prospect for long-term storage of cryogenic propellants.

### SUMMARY OF THE INVENTION

Various applications require working with/at cryogenic temperatures. Examples are, e.g., found in cryopreservation and cold chain transportation. At cryogenic temperatures, such as below 200 K, atoms are slowed down and therefore conservation of goods is possible for a longer duration. A common method to cool down to cryogenic temperatures is done by using cryogenic liquids or dry ice (carbon dioxide in the solid state). Cryogenic liquids are normally at their saturation temperature, i.e., boiling temperature. Any heat transferred to the liquid will cause evaporation, thereby reducing the amount of liquid but keeping it at a constant temperature. Likewise, heat transferred to dry ice may induce sublimation of the dry ice, wherein the (solid) dry ice is kept at a constant temperature.

In the medical field often dry shippers are used to transport medical samples. A dry shipper is a cryogenic storage dewar (or in short “dewar”) filled with liquid nitrogen to cool the medical samples. For safety reasons, the liquid nitrogen is absorbed in a porous material to prevent a possible spillage. The time needed to absorb the liquid nitrogen into the porous material in a standard dewar is impractically long, i.e., about 12 hours. It is expected that this time will significantly decrease when filling the dry shipper with subcooled nitrogen.

The terms “subcooled” (also called “undercooled”), “subcooling”, “undercooling”, and the like, refer to a liquid at a temperature below its normal boiling point (at a given pressure). For instance water at ambient pressure boils at 373 K. Therefore, water at room temperature is indicated as “subcooled”. Likewise, liquid nitrogen (LN₂) at ambient pressure has a boiling point of 77 K and is called subcooled at temperatures below 77 K (at 1 atm.). Herein, the terms “subcool(ing)” and “sub-cool(ing)” may both be used. Likewise “sub-cooled” and “subcooled” may be used interchangeably. Further, the term “saturated”, such as in “saturated cryogenic liquid” relates to a liquid at its boiling point. Referring to the examples above, liquid nitrogen at 77 K (and ambient pressure) is a saturated cryogenic liquid.

Known methods to subcool a cryogenic liquid may place high demand on the equipment used. For instance, for the method described in U.S. Pat. No. 539,608, the liquid needs to be in a sturdy dewar permitting a pressure reduction (vacuum) to lower the saturation temperature. This method thus requires the dewar to withstand reduced pressures. Furthermore, this method requires additional piping to transfer the liquid once it is subcooled to a destination dewar or transport dewar. This connecting tubing may cause heat transfer into the tubing, increasing the liquid temperature. Further, this method is essentially a batch-wise method.

Further applications and systems, like described in CN108386708, are known for storing low temperature fluids, such as propellants. Also these applications apply closed vessels operated at a controlled pressure. Furthermore, dedicated pumps may be required for pumping the low temperature fluid around through the system to maintain the required low temperature.

Alternatively, methods are known that can be operated at atmospheric pressure. In these prior art methods, a non-condensable gas may be injected into the liquid. The injection of the non-condensable gas causes forced evaporation of the cryogenic liquid into the non-condensable gas resulting in subcooling of the liquid. The advantage of such method is that it may not require the dewar to withstand reduced pressures. The method, though, only works at temperatures close to the saturation temperature.

Hence, it is an aspect of the invention to provide an alternative method for subcooling a volatile fluid, which preferably further at least partly obviates one or more of above-described drawbacks. It is a further aspect of the invention to provide a system for subcooling a volatile fluid, which preferably further at least partly obviates one or more of above-described drawbacks.

The term “volatile fluid” may especially refer to a liquid composed of the volatile fluid, more especially to a cryogenic liquid. Moreover, the term “volatile liquid” may be used to refer to the volatile fluid. The volatile liquid is especially a cryogenic liquid. The volatile fluid (or cryogenic fluid) may especially be in a liquid state.

The present invention may have as object to overcome or ameliorate at least one of the disadvantages of the prior art, or to provide a useful alternative.

Hence, in a first aspect, the invention provides a method. The method is especially for subcooling a volatile liquid, such as a cryogenic liquid. In embodiments, the method may comprise providing a (fluid) discharge element in the volatile liquid. The discharge element may, e.g., be provided in a supply of the volatile liquid and/or in a container comprising the volatile liquid. The discharge element may be provided in the volatile liquid, wherein a first discharge element portion (of the discharge element) comprising a discharge element inlet opening “(inlet) opening” (for extracting volatile liquid) is configured in the volatile liquid. The discharge element comprises a first discharge portion. In further specific embodiments, see also below, the discharge element further comprises a further discharge element portion, (especially fluidically connected to at an extreme of the first discharge portion remote from the inlet opening). The discharge element is especially provided wherein the first discharge element portion is configured in the volatile liquid and further especially wherein the discharge element inlet opening is (also) configured in the volatile liquid. In specific embodiments, the method comprises configuring (or immersing) the first discharge element portion comprising the (inlet) opening in the volatile liquid (wherein the first discharge element portion and the opening are configured in the volatile liquid). Further, a further discharge element portion (of the discharge element) may be configured remote from the volatile liquid. The further discharge element portion may be configured for protruding from the volatile liquid. Further, especially, the method comprises providing the further discharge element portion protruding from the cryogenic liquid. (wherein the first discharge portion is immersed in the (supply of) the volatile liquid. In further specific embodiments, the first discharge element portion comprises a throttle element. The first discharge element portion, further, especially comprises a (n at least partly) heat conductive wall. In specific embodiments, the first discharge element portion is (entirely/completely) configured, such as immersed, in the volatile liquid. Hence, in embodiments, the (at least partly) heat conductive wall comprised by the first discharge portion, the (inlet) opening, and the throttle element are configured in the volatile liquid. If the throttle element is configured in the volatile liquid, this may especially relate to a configuration wherein the heat conductive wall is configured between the throttle element and the volatile liquid. The method may in further embodiments comprise reducing a pressure in the discharge element at a downstream side of the throttle element (relative to a pressure of the cryogenic liquid), especially wherein the volatile liquid flows (or is induced to flow) from an upstream side of the throttle element through the throttle element (to the downstream side of the throttle element). The pressure may in embodiment be reduced at a side of the throttle element opposite to a further (upstream) side of the throttle element that comprises the inlet opening. Further, especially, the volatile liquid may change phase (and especially may reduce in temperature) at the downstream side of the throttle element (based on a flow through the throttle element). Further, especially, thereby a heat flow from the volatile liquid (in the supply and/or container) to the first discharge element portion may be provided (induced). Especially, as a result of the heat flow, the volatile liquid (in the supply and/or container) is subcooled. The volatile (or cryogenic) liquid may especially be cooled below a saturation temperature of the volatile (or cryogenic) liquid. In specific embodiments, especially wherein the volatile liquid comprises liquid carbon dioxide, the volatile liquid may convert from a liquid state to a solid state as a result of the cooling.

In a further aspect, the invention provides a system (especially for subcooling a volatile liquid, especially a cryogenic liquid). In embodiments, the system comprises a discharge element, especially such as described above and further below. Further, the system especially comprises a pumping device. In further specific embodiments, the system further comprises a container for containing the volatile liquid. The discharge element especially comprises a first discharge element portion comprising a discharge element inlet opening. The discharge element may further comprise a further discharge element portion (especially fluidically connected to the first discharge element portion). Further, especially, the first discharge element portion comprises a throttle element and a heat conductive wall. In further specific embodiments, the pumping device is fluidically coupled to the discharge element. The pumping device may in embodiments be fluidically coupled to the further discharge element portion. The pumping device is especially configured for reducing a pressure in the discharge element at a downstream location of the throttle element, especially for providing the volatile liquid to flow from an upstream location of the throttle element through the throttle element, especially wherein the volatile liquid changes phase at the downstream side of the throttle element if the discharge element inlet opening and the first discharge element portion are configured in the volatile liquid (and further especially if the further discharge element portion is configured remote from the volatile liquid). The pumping device is especially coupled to the discharge element at an opposite side of the throttle element relative to the inlet opening. The system is especially configured for subcooling a volatile fluid (liquid)/cryogenic fluid in a container, especially in an open container. In specific embodiments, the system is configured for arranging (during use) the discharge element in a container, especially the container comprising a volatile liquid, even more especially wherein the first discharge element portion is immersed in the volatile liquid (cryogenic liquid). The system not necessarily comprises the container.

In specific embodiments, the system comprises a discharge element comprising a first discharge element portion, (ii) a further discharge element portion fluidically coupled to the first discharge element portion, and (iii) a pumping device (and optionally (iv) a container for containing the cryogenic liquid (especially containing the cryogenic liquid during use (of the method))), wherein the first discharge element portion comprises a discharge element inlet opening, a throttle element, and a heat conductive wall; and wherein the pumping device is fluidically coupled (connected) to the further discharge element portion and configured for reducing a pressure in the discharge element at a downstream location of the throttle element, for providing the cryogenic liquid to flow (or “inducing a flow of the cryogenic liquid”) from an upstream location of the throttle element through the throttle element, wherein at least part of the cryogenic liquid changes phase at the downstream side of the throttle element if (the discharge element inlet opening and) the first discharge element portion is (are) configured in (immersed in) the cryogenic liquid (in the container) and the further discharge element portion protrudes from the cryogenic liquid (in the container).

In specific embodiments, the system comprises a (the) container for containing the cryogenic liquid, especially wherein the container is an open container. The container especially contains the cryogenic liquid.

The system may be used in the method of the invention. Moreover, in embodiments, the method comprises providing the system of the invention. The method and the system of the invention may advantageously be less complex that prior art methods. The method may be a continuous method. The method may provide a continuous subcooling process. The method may (in most embodiments) not require pressurization of the volatile liquid. The system may also in embodiments not required to be configured for the pressurization. The system may in embodiments only require the discharge element being configured for a reduced pressure. The system may be assembled from simple (non-complex) devices that may be used in all kinds of scales. Prior art systems may especially be suitable for large scale operations. Scaling it down to small scale operations, such as for cooling of samples like tissue may not be an option for many prior art systems. The systems may comprise less elements (devices) than prior art solutions. The system may comprise a rather simple pumping device. The pumping device may in embodiments not require rotating parts such as in a positive displacement pump. a centrifugal pump or an axial-flow pump (that may be subjected to increased maintenance). Hence, operating the system as well as assembling the system may be less complex. Furthermore, in embodiments, no electrical devices may be part of the system. Moreover, by the method of the invention lower (subcooled) temperatures may be obtained compared to prior art solutions based on injecting a non-volatile into the volatile liquid. Furthermore, with this method (compact) dry ice may be provided in a less complicated way than with prior art methods.

The method and the system may now first be explained based on further specific embodiments. The invention may be explained based on a cryogenic liquid. Yet, the method (and the system) described herein may more generally be based on a volatile liquid. In embodiments, the fluid may especially be volatile at reduced pressures (below 1 atm., e.g. below 50 kPa, such as below 10 kPa). Hence, the term “cryogenic liquid” may in embodiments be replaced by the term “volatile liquid” and vice versa. Moreover the term “volatile” may be interpreted broadly and may e.g. refer to water.

In embodiments, the discharge element may comprise or function as a heat exchanging element (or in short “heat exchanger”). The discharge element may, e.g., comprise a channel or a tube comprising the throttle element and (the discharge element) is especially configured to facilitate an exchange of heat between the channel or tube and a location external of the channel/tube. The throttle element especially comprises a flow restriction, e.g., in embodiments defined by the inlet opening. In specific embodiments, the throttle element may comprise an (inlet) orifice. Because the channel (including wall) may exchange heat, the channel may also be referred to as heat exchanging channel or “heat exchanger”. Moreover, at least part of the first discharge element portion may be referred to as heat exchanger. The heat exchanger with the throttle element (e.g., the orifice) may be immersed in a (closed or open) container or dewar filled with a (saturated) cryogenic liquid, such as liquid nitrogen. When pumping (extracting), the pressure in the discharge element is reduced, and the cryogenic fluid may be forced (extracted) through the throttle element, such as the orifice (functioning as the throttle element). When the pumping starts, part of the liquid will throttle through the throttle element. Based on the throttling, (part of) the cryogenic liquid may change phase from the liquid phase (or “liquid state”) to the gas phase (or “gaseous state”). The cryogenic liquid, especially a part of the cryogenic liquid, may change to a vapor. Additionally or alternatively, (part of) the cryogenic liquid may change phase to the solid phase. The method may comprise reducing the pressure in the discharge element at the downstream side of the throttle element to throttle the cryogenic through the throttle element, wherein a state of the cryogenic liquid changes, especially from a single-phase cryogenic liquid to a mixture of liquid and vapor (of the cryogen). In further embodiments the state of the cryogenic liquid changes from the single phase cryogenic liquid to a mixture of vapor and solid (cryogen). The (single-phase) cryogenic liquid may especially change phase to a mixture of liquid and vapor (a two-phase mixture), especially having a reduced temperature (relative to the temperature of the (single-phase) cryogenic liquid). This process may also be known as the Joule-Thomson process, which describes the temperature change when a liquid expands from a high pressure to a low pressure in an isenthalpic process. In further specific embodiments (especially below the triple point, see below), after throttling the liquid changes phase to a mixture of solid and vapor, especially at a reduced temperature (relative to the temperature of the (single-phase) cryogenic liquid).

In specific embodiments, the pressure in the heat exchanger (discharge element) may be set to a value lower than the triple point (pressure) of the cryogenic liquid, such as lower than 0.125 bar if liquid nitrogen is the cryogenic liquid. In such case, the cryogenic liquid (e.g. nitrogen) may be converted into its solid phase and gas phase. The resulting solid and gas phase cryogen (nitrogen) will have a lower temperature than the liquid cryogen, being defined by the exact pressure. The temperature difference between the inside of the heat exchanger and the cryogenic liquid around the discharge element (e.g., in the container) may induce a heat transfer from the cryogenic liquid (in) to the discharge element. Due to heat transfer from the liquid through a wall of the discharge element, cooling of the liquid cryogen surrounding the discharge element (heat exchanger) may take place. Moreover, due to the heat exchange and convection through the gas inside the discharge element, a solid phase of the cryogen if present will sublime, resulting in an enhanced cooling of the cryogenic liquid surrounding the discharge element (heat exchanger). Experimentally it has been shown that using this method, liquid nitrogen can be simply subcooled by reducing the pressure in the discharge element to below 0.125 bar to a temperature of 66 K, which is 11 K below the saturation temperature of liquid nitrogen.

In the above-described explanation/embodiment, the term “heat exchanger” is used. The term may be used herein referring to (at least a portion of) discharge element, especially (at least a portion of) the first discharge element portion. The term is especially used to indicate a function of the first discharge element portion, i.e., facilitating a heat exchange between (the bulk of) the cryogenic liquid (external of the discharge element) and the gaseous and optional solid phase or liquid of the cryogenic fluid inside the discharge element. The term “heat exchanger” used herein may especially refer to an (heat exchanging) element facilitating a heat flow between a more or less stagnant cryogenic fluid contacting an outer surface of the heat exchanger (discharge element) and a flowing and optionally sublimated cryogenic fluid contacting an inner surface of the heat exchanger. The discharge element (heat exchanger) may at least comprise a heat conductive wall between the outer surface and the inner surface (connecting the outer surface to the inner surface) of the heat exchanger, see also further below.

The term “more or less stagnant” in “more or less stagnant cryogenic fluid” is especially used to indicate the difference with the cryogen that is pumped into (through) the discharge element. It does not exclude embodiments of the method wherein the cryogenic fluid is moved, such as stirred, e.g. to level the temperature in (the bulk of) the cryogenic liquid.

Hence, the invention provides, in embodiments, a method (for subcooling a cryogenic liquid), wherein the method comprises providing a discharge element in a (supply of) cryogenic liquid, wherein a first discharge element portion comprising a discharge element inlet opening is configured in the cryogenic liquid (and optionally wherein a further discharge element portion may be configured remote from (or protruding from) the cryogenic liquid), wherein the first discharge element portion comprises a throttle element and wherein the first discharge element portion comprises a heat conductive wall; and reducing a pressure in the discharge element at a downstream side of the throttle element, wherein the cryogenic liquid flows (is induced to flow) from an upstream side of the throttle element through the throttle element, wherein at least part of the cryogenic liquid changes phase at the downstream side of the throttle element, thereby providing a heat flow from the cryogenic liquid (in the supply) (in) to the first discharge element portion.

In specific embodiments, the invention provides a method (for subcooling a cryogenic liquid), wherein the method comprises providing a discharge element comprising a first discharge element portion comprising (i) a discharge element inlet opening, (ii) a throttle element, and (iii) a heat conductive wall; providing a cryogenic liquid in an open container; immersing the first discharge element portion in the cryogenic liquid in the open container (10), and reducing a pressure in the discharge element at a downstream side of the throttle element, thereby inducing a flow of the cryogenic liquid from an upstream side of the throttle element through the throttle element, wherein at least part of the cryogenic liquid changes phase at the downstream side of the throttle element, thereby providing a heat flow from the cryogenic liquid surrounding the discharge element to the first discharge element portion.

Further, the invention provides, in embodiments, a system (for subcooling a cryogenic liquid), wherein the system comprises (i) a discharge element comprising a first discharge element portion comprising a discharge element inlet opening (and further especially a further discharge element portion (fluidically connected to the first discharge element portion), wherein the first discharge element portion comprises a throttle element and a heat conductive wall, and (ii) a pumping device; wherein the pumping device is fluidically coupled to the discharge element (and especially in embodiments to the further discharge element portion) and configured for reducing a pressure in the discharge element at a downstream location of the throttle element, for providing cryogenic liquid to flow from an upstream location of the throttle element through the throttle element, wherein at least part of the cryogenic liquid changes phase at the downstream side of the throttle element if the discharge element inlet opening and the first discharge element portion are configured in the cryogenic liquid (and optionally wherein the further discharge element portion is configured remote from the cryogenic liquid). In further embodiments, the system further may comprise a container for containing cryogenic liquid.

In further specific embodiments, the invention provides a system (for subcooling a cryogenic liquid), wherein the system comprises (i) a discharge element comprising a first discharge element portion, (ii) a further discharge element portion fluidically connected to the first discharge element portion, and (iii) a pumping device, wherein the first discharge element portion comprises a discharge element inlet opening, a throttle element and a heat conductive wall; wherein the pumping device is fluidically coupled to the further discharge element portion and configured for reducing a pressure in the discharge element at a downstream location of the throttle element, for providing the cryogenic liquid to flow from an upstream location of the throttle element through the throttle element, wherein at least part of the cryogenic liquid changes phase at the downstream side of the throttle element if the discharge element inlet opening and the first discharge element portion are configured in the cryogenic liquid and the further discharge element portion protrudes from the cryogenic liquid.

The terms “upstream” and “downstream” relate to an arrangement of items or features relative to the propagation of an element such as a particle or a fluid in a channel, flow path, or hydraulic circuit, wherein relative to a first position within the channel, flow path or circuit, a second position in the channel, flow path or hydraulic circuit to an inlet (for the fluid or particle) of the channel, flow path or hydraulic circuit is “upstream”, and a third position within the channel, flow path or circuit further away from the inlet “downstream”. For instance, herein the bulk of the cryogenic liquid is arranged upstream of the (inlet) opening. The further discharge element portion is especially arranged downstream of the first discharge element portion.

The method and the system are especially for subcooling a volatile fluid, especially a liquid composed of a volatile fluid (“volatile liquid”). In accordance with the present invention a saturated volatile liquid is (sub) cooled by reducing the pressure, wherein the (saturated) volatile liquid changes to a two-phase mixture (liquid/vapor or in embodiments vapor/solid) at a lower temperature relative to the temperature of the saturated volatile liquid, providing a driving force for heat from the saturated volatile liquid to the colder two-phase mixture, causing cooling of the saturated volatile liquid. The subcooling is especially based on a phase change wherein at least part of the volatile liquid/cryogenic liquid changes phase from the liquid state to the gaseous and optionally solid state at a lower temperature.

Herein, the term “phase” such as in phrases like “wherein the fluid changes phase”, “phase changing of the fluid”, and the like especially relate to a state of fluid that changes. The fluid may e.g. change from the liquid state to the gaseous state (“vaporize”; from a liquid to a vapor), from a liquid state to a solid state (“solidify”), or e.g. from a solid state to a gaseous state (also named “sublime”). The terms “gas phase”, “gaseous phase” and “vapor phase” may be used interchangeably, especially referring to a state (or phase) of the fluid at a temperature above the boiling point of the fluid (at the given pressure (of the fluid)). The term “changing phase” may further especially refer to a change from a single phase (liquid) to a two-phase system. As is indicated above, the single liquid phase may in embodiments change to a two-phase mixture comprising liquid and vapor. This may further be indicated as part of the liquid changes phase. The cryogenic liquid may further change to a two-phase mixture of vapor and solid. Hence, changing phase may also refer to a single (liquid) phase changing to a (mixture of) a solid phase and a gaseous phase. Further, the phrase “wherein at least part of the cryogenic liquid changes phase” may refer to the (single phase) cryogenic liquid changes to a two-phase mixture”. The term “two-phase mixture may refer to a mixture comprising the liquid and vapor (of the cryogenic liquid). The term may also refer to a mixture comprising a combination of the cryogenic liquid in the vapor state and in the solid state).

The discharge element is especially used for discharging, extracting, or releasing some of the cryogenic fluid (from a container/supply). The discharge element may comprise an (inlet) opening for allowing the cryogenic liquid to enter the discharge element, especially when the part of the discharge element comprising the opening is arranged in the cryogenic liquid. The part of the discharge element comprising the opening may herein also be referred to as the first discharge element portion. Said part further especially comprises the throttle element and the heat conductive wall. More especially the first discharge element portion comprises the heat exchanger (and the inlet opening). The first discharge element portion and the further discharge element portion may define the discharge element (optionally in combination with an extra portion of the discharge element connecting the first and further portion). The first and second discharge element portion may define a channel or duct from the inlet opening to a discharge of the discharge element (optionally via a pumping device and an extra portion of the discharge element configured between the first and further discharge element portion).

The term “(inlet) opening” may refer to a plurality of (different) inlet openings. The discharge element may comprise more than one inlet opening. The plurality of openings are especially all immersed in the cryogenic liquid during use of the method.

The discharge element may have any size and/or configuration. Essentially, the discharge element comprises an inner space or volume, especially for holding a fluid and/or guiding/conducting the fluid. The space may be confined by an inner surface of the discharge element. The space may define a channel and/or any arbitrary space. The space may in embodiments define a tube or a duct. Furthermore, the space may define any arbitrary volume. In specific embodiments, the discharge element, especially the first discharge element portion, comprises a fluid flow channel. The fluid flow channel may especially be defined by a tube.

Further, the space in the discharge element, especially at a location of the first discharge element portion, may comprise a (fluid) flow restriction. The flow restriction may comprise or define the throttle element. The flow restriction may comprise a reduction in cross-sectional (flow-through) area of the space (and/or channel). The flow restriction may in embodiments comprise a porous element configured in the space. The porous element may comprise pores allowing a fluid to flow through. The porous element may in embodiments comprise a sintered metal plate. In further embodiments, the porous element may comprise an inorganic porous material. The flow restriction may in further embodiments comprise a cavity or narrowing. The flow restriction may comprise a capillary or capillary tube. The flow restriction may especially be configured for resulting in a pressure drop over the flow restriction when a fluid flows through the flow restriction.

The throttle element may in embodiments comprise one or more of a cavity, a porous element, and a capillary tube. In further embodiments, the discharge element inlet opening comprises an orifice defining the throttle element. The flow-through area of flow restriction, especially the orifice, may in further embodiments be selected based on the desired cooling capacity and/or time to subcool the cryogenic liquid. For instance, in embodiments the orifice may have a diameter of 100 μm allowing to subcool 1 liter of cryogenic liquid at least a few degrees centigrade in about 10 minutes. The orifice may in further embodiments have a diameter in the range of 1-1000 μm, especially 10-1000 μm, such as 10-50 μm. A further embodiment may comprise a plurality of orifices (in a single discharge element or in a plurality of discharge elements allowing to cool a larger volume of cryogenic liquid or allowing to more rapidly subcool the cryogenic liquid. A flow rate through an orifice is especially a function of two parameters, i.e., the orifice diameter and the pressure drop. For a fixed pressure drop, the orifice diameter may especially be selected depending on the desired flow. For large containers, a relatively large flow may be desired (to increase a cooling power). Therefore, especially an orifice diameter or other restriction may be selected based on the desired flow rate and the size of the system.

In further embodiments, the throttle element may comprise a controllable flow restriction. The throttle element may e.g. comprise a valve. The valve may in embodiments be set (or controlled) before providing the discharge element in the cryogenic liquid. In further specific embodiments, the valve may be configured for actuating (i.e. changing the flow restriction) during use. Hence, in embodiments, the flow restriction is controlled (changed) during flowing the fluid through the throttle element. Moreover, in embodiments the method comprises controlling (a flow through area of) the flow restriction.

The throttle element is especially configured in the discharge element at a location that is immersed in the cryogenic liquid during use of the method.

The terms “flow restrictions” and “throttle element” may independently from each other refer to a plurality of (different) flow restrictions and/or throttle elements. Further, in embodiments a single throttle element may comprise a plurality of flow restrictions. The throttle element may e.g. comprise a capillary tube comprising a porous element optionally further including a valve. Furthermore, the term “first discharge element portion” may in embodiments refer to a plurality of (different) first discharge portions.

The discharge element further especially comprises an outer surface for directly contacting the cryogenic liquid (at a location of the first discharge element portion). It is noted that the term “first discharge element portion” not necessarily refers to a specific fraction of the discharge element. The term may especially refer to a portion of the discharge element that at least comprises the part of the discharge element that during use is arranged in the cryogenic liquid (especially comprising the heat exchanger). In embodiments, the wall of the first discharge element portion may extend into (the wall of) the further discharge element portion. Especially, (only) the part of the discharge element (to be) provided in the cryogenic liquid may in embodiments be referred to as the first discharge element portion. Essentially, the cryogenic fluid may enter the discharge element via the inlet opening of the first discharge element portion. Furthermore, heat may be transferred between the external surface of the first element portion and the internal surface of the first discharge element portion. Therefore, at least part of the wall of the discharge element, especially of the first discharge element portion, linking the internal surface to the external surface, may conduct heat. At least part of the wall may e.g. be made of a heat conductive material, e.g. a metal, such as copper, brass, and stainless steel.

In further specific embodiments, the first discharge element portion is configured for enhancing exchange of heat between the heat conductive wall and external from the discharge element. The first discharge element portion may be configured for maximizing a heat exchanging surface. The first discharge element portion may in specific embodiments comprise one or more heat conductive extensions extending from the heat conductive wall. These extension(s) together with the heat conductive wall may in embodiments define the heat exchanger. The heat exchanger may in embodiments enclose the throttle element. The heat conductive wall especially encloses the throttle element. The heat conductive wall is especially configured heat conductively coupled to the throttle element.

By reducing the pressure in the discharge element, the cryogenic fluid may flow through the flow restriction and/or throttle element, especially resulting in a change of state (or phase change) of (at least part of) the cryogenic liquid (cryogenic fluid). Depending on the pressure, all of the cryogenic fluid flowing through the throttle element may change into a two-phase mixture of the liquid and the gaseous state. Yet, in other embodiments a first part of the liquid may convert to the gas state and a second part of the liquid may convert to the solid state (or phase). The terms “state” and “phase” when referring to the state of the cryogen (liquid/gas/solid) may be used interchangeably herein.

In embodiments, the pressure in the discharge element at the downstream side of the throttle element may be reduced to a pressure selected to be below a pressure of the cryogenic liquid (in the supply). This way the liquid cryogen may change into a two-phase mixture downstream of the throttle element, and the relatively colder two-phase mixture may take up heat from the liquid cryogen via the heat conductive wall (and cool the cryogenic liquid), see further below.

It may further be advantageous when the liquid cryogen (based on the throttling) is at least partly converted to the solid state. The solid cryogen may than sublime when heat is transferred from the cryogenic liquid to the cryogen in the solid state (inside the discharge element). The change of state from solid to gas may extract an additional amount of heat from the cryogenic liquid, resulting in a further temperature reduction of the cryogenic liquid. Throttling of the cryogenic liquid may result in a combination of solid cryogen and gaseous cryogen if throttling takes place below the triple point of the cryogenic fluid. The triple point of the cryogen is a function of the type of cryogen. In the next table, triple point data for some possible cryogens (see further below) is given.

| | Triple point | Triple point |
|---|---|---|
| | pressure | temperature |
| Cryogen | [kPa] | [K] |
| Nitrogen | 12.6 | 63.18 |
| Neon | 43.3 | 24.55 |
| Argon | 68.9 | 83.81 |
| Krypton | 74.1 | 115.76 |
| Carbon dioxide | 517 | 216.55 |
| Hydrogen | 7 | 13.81 |
| Methane | 11.7 | 90.68 |

Hence, in further embodiments, the pressure in the discharge element at the downstream side of the throttle element may be reduced to a pressure selected to be below a triple point pressure of the cryogenic liquid.

Basically, the pressure of the cryogenic liquid may be any arbitrary pressure as long as the pressure is higher than the pressure provided in (the space of) the discharge element. Yet, it may be advantageous if the cryogenic liquid is not pressurized and/or vacuumized. The pressure of the cryogenic liquid may be substantially ambient pressure (around 1 atm, or 1 bar). Hence, in specific further embodiments the method comprises maintaining a pressure of the (atmosphere surrounding the) cryogenic liquid (in the supply of cryogenic liquid) at atmospheric pressure (or ambient pressure). The method may, e.g., comprise supplying the cryogenic liquid in an open container (to provide the supply of cryogenic liquid). The open container may essentially be open to the atmosphere, resulting in an ambient pressure of about 1 atm. (101,325 Pa). The cryogenic liquid (in the open container and/or surrounding the first discharge element portion) is in specific embodiments configured at an ambient (or atmospheric) pressure.

In specific embodiments the method comprises providing the cryogenic liquid in an open container and providing the discharge element in the cryogenic liquid in the open container. In specific embodiments, the container contains/comprises the cryogenic (or “volatile”) liquid.

Hence, in embodiments, the container is an open container. The term “open” in “open container” especially indicates that the container is in open fluid connection with external of the container, such as with a room in which the container is configured. Such room may be configured at ambient conditions. In further embodiments the container may be configured in a room having a controlled temperature and/or controlled pressure. Therefore using an open container does not exclude pressures over or under 1 bar (of the cryogenic liquid). Furthermore, the open container may have a closure or lid. The open container is especially not hermetically closed.

In further specific embodiments, reducing the pressure in the discharge element (thus) comprises reducing the pressure to a pressure being lower than 1 bar (absolute) in the discharge element (at the downstream side of the throttle element). The method may especially comprise reducing the pressure to a pressure being lower than a triple point pressure of the cryogenic liquid. In specific embodiments, the cryogenic liquid is nitrogen and reducing the pressure in the in the discharge element comprises reducing the pressure selected to be lower than 0.125 bar (absolute) in the discharge element (at the downstream side of the throttle element).

In further specific embodiments, the container comprises a closed container. A closed container may e.g. be used when using dangerous or e.g. flammable volatile liquids like hydrogen or methane. A closed container may be used to prevent oxygen from air condensing in the container which may form a dangerous mixture. A closed container may further advantageously be used for allowing pressurizing the cryogenic liquid. The method may comprise closing the container. Additionally or alternatively, the room comprising the container is closed (preventing vapor to exit the room or container in an uncontrolled way).

The reduced pressure may be provided using a pumping device. The pumping device may especially be configured for pumping the cryogenic fluid. The pumping device may be made of material compatible with the cryogenic fluid. The pumping device may comprise (be) a vacuum pump. In specific embodiments, the pumping device may comprise a venturi vacuum system. A venturi vacuum system is known by the skilled person and may also be known as “vacuum ejector” or simply “ejector” and is based on a flow of a working fluid which generates a vacuum due to Bernoulli's principle (see also below). The venturi vacuum system may be configured for a liquid working fluid. Yet, it may be advantageous to use a working fluid that may not be susceptible to freezing during using the method. Hence, in further embodiments, the venturi vacuum system may be configured for a gaseous working fluid. The gaseous working fluid may especially be dehumidified before use.

In specific embodiments, the system (and the method), may be configured to optimize a use of the energy or enthalpy. In embodiments, e.g., a portion of the discharge element may be made of heat (or cold) insulating material. For instance, the further discharge element portion or a portion of the discharge system between the first discharge element portion and the further discharge element portion may be configured to prevent a conduction of heat (cold), especially to prevent a leakage of cold away for the discharge system and/or away from the cryogenic liquid.

In further specific embodiments, the method may comprise precooling the first discharge element portion before providing the first discharge element portion in the cryogenic liquid. The first discharge element portion may e.g. be cooled to below room temperature. The first discharge element portion may especially be cooled to a temperature equal to or below the saturation temperature of the cryogenic liquid, especially equal to or below the temperature of the cryogenic liquid (in the supply and/or container).

Hence, in further embodiments, the method further comprises pre-cooling at least the first discharge element portion to a precooling temperature, prior to providing the first discharge element portion in (the supply and/or container of) the cryogenic liquid. Moreover, in specific embodiments, the method further comprises pre-cooling at least the first discharge element portion (of the discharge element) to a precooling temperature, prior to immersing the first discharge element portion in the cryogenic liquid. The precooling temperature is in embodiments selected to be equal to or lower than 273.15 K. In further embodiments the precooling temperature is selected to be equal to or lower than a temperature of the cryogenic liquid (in the supply and/or container).

As discussed above, herein the term “cryogenic liquid” may in embodiments be substituted by the term “volatile liquid” and vice versa. The term cryogenic liquid may though especially refer to a cryogenic liquid known to the skilled person. Examples of cryogenic liquids are, e.g., nitrogen (N₂), helium (He), neon (Ne), argon (Ar), krypton (Kr), hydrogen (H₂), liquified natural gas (LNG) or (liquified) methane (CH₄) and oxygen (O₂) (all in the liquid phase). A further example of a cryogenic liquid (or cryogen) is carbon dioxide (CO₂). Carbon dioxide at atmospheric conditions is in the gas state. Yet, carbon dioxide may be in the liquid state at elevated pressures above 5.1 atm and at a temperature under 31.1° C. (temperature of the critical point) and above −56.6° C. (temperature of the triple point).

Cryogenic liquids are volatile fluids that normally are in the gas phase at ambient conditions (1 atm, and room temperature). Most of the cryogenic liquids have a boiling temperature at 1 atm. below −150° C. In this respect, carbon dioxide is different from most cryogenic liquids, as it may directly sublime from solid carbon dioxide (also known as “dry ice”) to the gaseous state at 1 atm (since the triple point pressure is above 1 atm.). Most cryogenic liquids can be regarded as (cryogenic) gasses that are extremely cooled wherein they are converted in their liquid state. Again, carbon dioxide is different and (also) requires pressurizing to become in the liquid state.

Herein, the term “cryogenic fluid” may also be used when referring to the cryogen in the gas state or solid state (although actually not being fluid). The term may further refer to the cryogenic liquid as a chemical substance in general. The term “cryogenic liquid” may especially refer to the cryogenic fluid in the liquid state. However, the term may herein also be used more generally to the substances known as cryogenic liquids, such as listed above as a cryogenic liquid, independently from the state of matter of the substance. Moreover, the terms “cryogenic liquid”, “cryogenic fluid” and “cryogen” may be used interchangeably, especially referring to one or more of the substances described above in relation to the cryogenic liquids. The term “cryogenic liquid” may in embodiments refer to the cryogen at ambient conditions (1 atm.). In further embodiments, it may refer to the cryogen at elevated pressures (especially in relation to (liquid) carbon dioxide)

Hence, in embodiments, the cryogenic liquid is selected from the group consisting of nitrogen, helium, neon, argon, krypton, hydrogen, liquified natural gas (LNG), methane oxygen and carbon dioxide. The cryogenic liquid is in further embodiments selected from the group consisting of nitrogen, neon, argon, krypton, hydrogen, liquified natural gas (LNG), carbon dioxide, and optionally methane. In specific embodiments the cryogenic liquid is (liquid) nitrogen. The cryogenic liquid may in further embodiments be carbon dioxide. In further embodiments, the cryogenic liquid is (liquid) argon. In yet further embodiments, the cryogenic liquid is liquified natural gas (LNG). The cryogenic liquid may especially be (liquid) hydrogen. Moreover, the cryogenic liquid may in embodiments be selected from the group consisting of nitrogen, argon, carbon dioxide, liquified natural gas (LNG), and hydrogen.

Cryogenic fluids may be classified as inert fluids (such as nitrogen, helium, neon, argon, and krypton and carbon dioxide), flammable fluids (hydrogen, methane, and liquefied natural gas), and oxygen. In embodiments, therefore the cryogenic fluid, especially an inert cryogenic fluid, may be discharged (from the discharge element) to the atmosphere (or e.g., “air” or “surroundings”). Therefore, in embodiments, the discharge element, especially the further discharge element portion, may comprise an outlet opening in open fluid connection (optionally via the pumping device) with the atmosphere. In other embodiments, the discharged cryogenic fluid may not directly be discharged to the atmosphere. The discharged cryogenic fluid may e.g. be captured in a vessel or may be flared. For instance discharged LNG, methane, or hydrogen gas may be burnt in embodiments. The burning may in further embodiments be used to produce electricity (directly or after storage/capturing).

Hence, in embodiments, the system may further comprise (or be functionally coupled to) a flare system fluidically coupled the discharge element, especially to the further discharge element portion. Further, the method may comprise burning the cryogenic fluid exiting the discharge element, and optionally producing electricity by burning the cryogenic fluid.

The term “flow through” in expressions like “flow through channel” or “flow through area” especially refers to a structure or device such as a channel wherein a fluid may enter the structure or device at a first location (or end) and exit the structure or device at a further location (or end), different from the first location.

In this application, the feature “cross sectional area” is used. In that respect, the cross-sectional area can also be indicated as the flow-through cross-sectional area or cross section. This cross-sectional area can be rectangular, elliptic, or round (such as a ring), for instance.

### BRIEF DESCRIPTION OF THE DRAWINGS

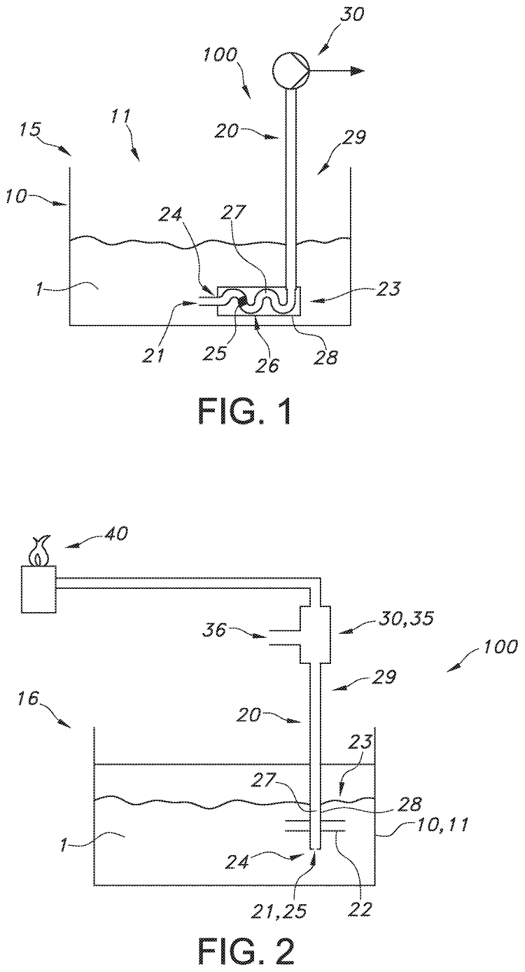

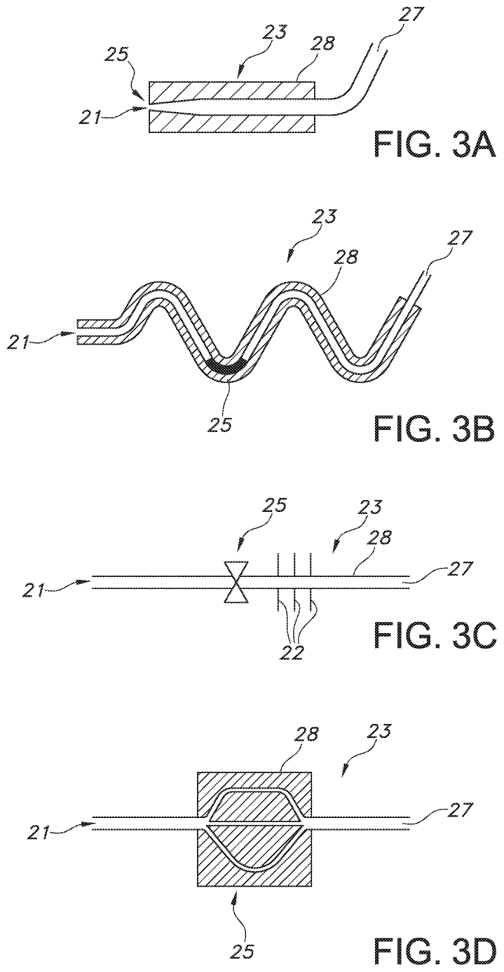

Embodiments of the invention will now be described, by way of example only, with reference to the accompanying schematic drawings in which corresponding reference symbols indicate corresponding parts, and in which FIGS. 1-2 schematically depict embodiments of the system and FIG. 3 depicts some further aspects of the discharge element. The schematic drawings are not necessarily to scale.

### DETAILED DESCRIPTION OF THE EMBODIMENTS

FIG. 1 as well as FIG. 2 schematically depict embodiments of the system 100. The figures further schematically depict aspects of the method. The system 100 is especially configured for subcooling a volatile liquid, especially a cryogenic liquid 1, such as nitrogen, neon, argon, krypton, hydrogen, carbon dioxide, or liquified natural gas (LNG). Herein, this may also be referred to as a supply 11 of cryogenic liquid 1 (or volatile liquid (or cryogenic liquid 1) supply 11). In the depicted embodiments, the system 100 comprises a container 10 containing cryogenic liquid 1, a discharge element 20 and a pumping device 30. The container 10 may comprise any arbitrary holder or container, e.g. a dewar, to house the cryogenic liquid 1 and not necessarily is part of the system 100. The container 10 may be open, see FIG. 1; the container may also be a closed container 10, 16, see FIG. 2. The method may comprise closing the container 10. The discharge element 20 comprises a first discharge element portion 23 with a discharge element inlet opening 21 ((inlet) opening 21). The depicted discharge element 20 further comprises a further discharge element portion 29 that protrudes from the cryogenic liquid 1. Basically the terms “first discharge element portion” 23 and the “further discharge element portion” 29 may be used to indicate locations/functions of the discharge element 20. Especially, the first discharge element portion 23 is configured for arranging in the cryogenic liquid 1 and for extracting heat from the cryogenic liquid 1. Therefore, the first discharge element portion 23 comprises a throttle element 25 and a heat conductive wall 28. The further discharge element portion 29 extends from the first discharge element portion 23 in the given embodiments. Alternatively, an intermediate discharge element portion (not depicted) may be configured between the first discharge element portion 23 and the further discharge element portion 29. Essentially, there is a flow path or channel 27 created from the inlet opening 21, via the throttle element 25 to an extreme of the discharge element 20 opposite to the inlet opening 21 (connected to the pumping device 30 depicted in the figures). The figures further depict that the (entire) first discharge portion 23 is immersed in the cryogenic liquid 1, and especially that the further discharge element portion 29 protrudes from the cryogenic liquid 1 supply 11.

The throttle element 25 defines a flow restriction (in the channel 27) and may induce a pressure drop when the cryogenic fluid 1 is throttled through the throttle element 25. The throttle element 25 in FIG. 1, comprises a porous element. The throttle element 25 in FIG. 2 is defined by the inlet opening 21, see further also FIG. 3.

When actuating the pumping device 30, a pressure in the discharge element 20 at a downstream side 26 of the throttle element 25 is reduced. As a result of the pumping, the cryogenic liquid 1 flows from the upstream side 24 of the throttle element 25 through the throttle element 25. The terms “downstream” and “upstream” in “upstream side” 24 and “downstream side” 26 relate to a direction of flow of the cryogenic fluid 1. In FIG. 1 the throttle element 25 is configured inside of the first discharge element portion 23 and a direction of flow of the cryogenic fluid 1 being discharged from the discharge element 20 is depicted by the arrow exiting from the pumping device 30. Hence, the cryogenic fluid 1 may flow from the inlet opening 21 to the pumping device 30 (via the channel 27). In the given embodiment, the pumping device 30 is configured at a downstream location of the throttle element 25, whereas the inlet opening 21 is configured upstream of the throttle element 25. It is noted that the pumping device 30 not necessarily is configured at the end of the discharge element 20, but e.g. may also be incorporated in the discharge element 20. Furthermore, it is noted that in the embodiment of FIG. 2, the supply 11 of cryogenic liquid 1 is configured upstream of the throttle element 25 and the upstream side 24 of the throttle element 25 may be the extreme of the first discharge element portion 23.

When the (single phase) cryogenic liquid 1 throttles through the throttle element 25 at least part of the cryogenic liquid 1 changes phase and changes into to a two-phase mixture, and especially reduces in temperature at the downstream side 26 of the throttle element 25. Because of the reduced temperature inside the discharge element 20, heat may flow the cryogenic liquid 1 in the container 10 to the first discharge element portion 23 (via the wall 28). As such, the cryogenic liquid 1 in the container 10 is cooled below a saturation temperature of the cryogenic liquid 1. The cryogenic liquid 1 is especially subcooled (by the cooling).

The first discharge element portion 23 is especially configured for enhancing exchange of heat between the heat conductive wall 28 and external from the discharge element 20. Therefore, herein, at least part of the first discharge element portion 23 may also be referred to as “heat exchanger”. In the embodiment depicted in FIG. 2, for instance, the first discharge element portion 23 comprises two heat conductive extensions 22 extending from the heat conductive wall 28 to further facilitate the heat transport.

The pressure in the discharge element 20 at the downstream side 26 of the throttle element 25 is especially reduced to a pressure selected to be below a pressure of the cryogenic liquid 1 surrounding the discharge element 20 and may in embodiments be reduced to a pressure selected to be below the triple point pressure of the cryogenic liquid 1.

FIG. 1 further schematically illustrates that the cryogenic liquid 1 is supplied in an open container 15. In such embodiment, the method may especially comprise maintaining the pressure of the cryogenic liquid (in the container 10) at atmospheric pressure. The open container 15 may also be arranged in a pressurized (or vacuumed) room to maintain or control a pressure of the cryogenic liquid. Alternatively, the container 10 may be a closed container 16 allowing to control the pressure in the container 10.

Controlling the pressure at the cryogenic liquid 1 may e.g. be relevant when using carbon dioxide (CO₂) as cryogen 1. As described above, CO₂ does not boil at 1 atm.; instead, it sublimes (from solid to vapor). CO₂ is slightly different from other cryogenic liquids 1 described herein. The triple point pressure is greater than 1 atm. When CO₂ liquid 1 (at elevated pressure) is throttled a two-phase mixture of solid and vapor is obtained at a reduced temperature. The mixture may than extract heat from the liquid CO₂ 1 surrounding the first discharge portion 23. Unlike what is described for the other cryogenic liquids 1, this cooling may result in a phase change of the liquid CO₂ to the solid state (CO₂ has a sublimation temperature of about −78.5° C.). This way, compact/dense dry ice may be provided in one go, whereas in present methods first “snow” is made from the liquid CO₂ and successively the snow is compacted to provide the densified dry ice.

In embodiments of the method, the first discharge element portion 23 may be precooled to a precooling temperature, prior to immersing the first discharge element portion 23 in the cryogenic liquid 1. This may for instance be done by first immersing the first discharge portion 23 in the cryogenic liquid 1 (wherein some cryogenic liquid 1 may evaporate) and starting pumping when the first discharge element portion 23 is precooled.

Using the pumping device 30, the reduced pressure in the discharge element 20 is provided. The pumping device 30 may be any arbitrary pumping device 30, especially any vacuum device. The pumping device is especially configured for reducing the pressure downstream of the throttle element 25 and especially may be configured for providing a minimized flow of the cryogen 1 through the pumping device 30 The pumping device 30 may be a rather simple pumping device 30. The pumping device 30 may not require rotating parts such as in a positive displacement pump. a centrifugal pump or an axial-flow pump

In the embodiment of FIG. 2 the pumping device 30 comprises a venturi vacuum system 35 for reducing the pressure in the discharge element 20. Such venturi vacuum system may also be known as “vacuum ejector” or simply “ejector”. In examples of the ejector 35, a working fluid 36 flows through a jet nozzle into a tube that first narrows and then expands in cross-sectional area. The fluid 36 leaving the jet is flowing at a high velocity which generates a vacuum due to Bernoulli's principle. The outer tube then narrows into a mixing section where the high velocity working fluid 36 mixes with the (gaseous) cryogenic fluid 1 that is drawn in by the vacuum, imparting enough velocity for it to be ejected. The venturi vacuum system 35 may especially be configured for a gaseous working fluid 36.

In the in FIG. 1 depicted embodiment, comprising an open container 15 at ambient pressure, the pressure in the in the discharge element 20 is at least reduced to a pressure being lower than 1 bar (absolute) in the discharge element 20 (at the downstream side of the throttle element 25). In further specific embodiments, the pressure may be reduced to a pressure being lower than the triple point pressure of the cryogenic liquid 1. This way, part of the cryogenic liquid 1 may deposit in the solid phase downstream of the throttle element 25. When subliming again, an extra amount of heat may be extracted from the cryogenic liquid surrounding the first discharge element portion 23 (via the wall 28 of the discharge element 20).

FIG. 2 further schematically depicts the flare system 40 that is fluidically coupled the discharge of the discharge element 20. This may e.g. be used when having LNG, methane, or hydrogen gas as the cryogenic liquid 1, to burn the gaseous phases of these cryogenic liquids 1 that may exit the discharge element 20. Burning of these gasses may in embodiments coupled to producing electricity. To prevent the flammable cryogens 1 from escaping from the container 10, the used container 10 is closed/is a closed container 16.

In FIGS. 3A-3D some examples of aspects of the first discharge element portion 23 including throttle elements 25 are depicted. In FIG. 3A, the inlet opening 21 provides the flow restriction and especially defines the throttle element 25. Herein, such small inlet opening 21 may also be named “orifice”. Another example of the throttle element 25 comprises a porous element (indicated with the solid black element 25), as is schematically depicted in FIG. 3B. FIG. 3C depicts a throttle element 25 comprising a valve, as an embodiment of a controllable flow restriction. FIG. 3D depicts an embodiment of the throttle element 25 comprising three flow restrictions. In that embodiment, the flow channel 27 at the location of the throttle element 25 is divided in three smaller channels together functioning as the throttle element 25. FIGS. 3A-3D further schematically depict different types of fluid flow channels 27 and heat conductive walls 28 of/at the first discharge element portion 23.

The devices, apparatus, or systems may herein amongst others be described during operation. As will be clear to the person skilled in the art, the invention is not limited to methods of operation, or devices, apparatus, or systems in operation.

The system, or apparatus, or device may execute an action in a “mode” or “operation mode” or “mode of operation”. Likewise, in a method, an action or stage, or step may be executed in a “mode” or “operation mode” or “mode of operation”. The term “mode” may also be indicated as “controlling mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

The term “controlling” and similar terms herein especially refer at least to determining the behavior or supervising the running of an element, especially wherein the element is configured to adjust the treating of the damages skin tissue. Hence, herein “controlling” and similar terms may e.g. refer to imposing behavior to the (controllable) element (determining the behavior or supervising the running of an element), etc., such as e.g. measuring, displaying, actuating, opening, shifting, changing temperature, etc., especially actuating. Beyond that, the term “controlling” and similar terms may additionally include monitoring. Hence, the term “controlling” and similar terms may include imposing behavior on an element and also imposing behavior on an element and monitoring the element. The controlling of the element can be done with the control system. The control system and the (controllable) element may thus at least temporarily, or permanently, functionally be coupled. The element may comprise at least part of the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems.

The term “plurality” refers to two or more. Furthermore, the terms “a plurality of” and “a number of” may be used interchangeably.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%. Moreover, the terms “about” and “approximately” may also relate to 90% or higher, such as 95% or higher, especially 99% or higher, even more especially 99.5% or higher, including 100%. For numerical values it is to be understood that the terms “substantially”, “essentially”, “about”, and “approximately” may also relate to the range of 90%-110%, such as 95%-105%, especially 99%-101% of the values(s) it refers to. The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The term “further embodiment” and similar terms may refer to an embodiment comprising the features of the previously discussed embodiment but may also refer to an alternative embodiment.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, “include”, “including”, “contain”, “containing” and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings. Moreover, if a method or an embodiment of the method is described being executed in a device, apparatus, or system, it will be understood that the device, apparatus, or system is suitable for or configured for (executing) the method or the embodiment of the method, respectively.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A method for subcooling a cryogenic liquid (1), wherein the method comprises:
providing a discharge element (2) comprising a first discharge element portion (23) comprising (i) a discharge element inlet opening (21), (ii) a throttle element (25), and (iii) a heat conductive wall (28),
providing a cryogenic liquid (1) in an open container (10),
immersing the first discharge element portion (23) in the cryogenic liquid (1) in the open container (10), and
reducing a pressure in the discharge element (20) at a downstream side (26) of the throttle element (25), thereby inducing a flow of the cryogenic liquid (1) from an upstream side (24) of the throttle element (25) through the throttle element (25), wherein at least part of the cryogenic liquid (1) changes phase at the downstream side (26) of the throttle element (25), thereby providing a heat flow from the cryogenic liquid (1) surrounding the discharge element (20) to the first discharge element portion (23).

2. The method according to claim 1, wherein the discharge element (2) further comprises a further discharge element portion (29), wherein the method comprises providing the further discharge element portion (29) protruding from the cryogenic liquid (1) in the open container (10), wherein the first discharge element portion (23) is immersed in the cryogenic liquid (1), wherein a pumping device (30) fluidly coupled to the further discharge element portion (29) is applied for reducing the pressure in the discharge element (20) at the downstream side (26) of the throttle element (25).

3. The method according to claim 1, wherein the method comprises maintaining a pressure of the cryogenic liquid (1) in the open container (10) at atmospheric pressure.

4. The method according to claim 1, wherein the pressure in the discharge element (20) at the downstream side (26) of the throttle element (25) is reduced to a pressure selected to be below a triple point pressure of the cryogenic liquid (1).

5. The method according to claim 1, wherein the cryogenic liquid (1) is selected from the group consisting of nitrogen, argon, carbon dioxide, liquified natural gas (LNG), and hydrogen.

6. The method according to claim 1, comprising using a venturi vacuum system (35) for reducing the pressure in the discharge element (20).

7. The method according to claim 1, wherein the method further comprises pre-cooling at least the first discharge element portion (23) of the discharge element (20) to a precooling temperature, prior to immersing the first discharge element portion (23) in the cryogenic liquid (1), wherein the precooling temperature is selected to be equal to or lower than 273.15 K.

8. The method according to claim 7, wherein the precooling temperature is selected to be equal to or lower than a temperature of the cryogenic liquid (1).

9. A system (100) for subcooling a cryogenic liquid (1), wherein the system (100) comprises (i) a discharge element (20) comprising a first discharge element portion (23), (ii) a further discharge element portion (29) fluidically connected to the first discharge element portion (23), and (iii) a pumping device (30), wherein the first discharge element portion (23) comprises a discharge element inlet opening (21), a throttle element (25) and a heat conductive wall (28); wherein
the pumping device (30) is fluidically coupled to the further discharge element portion (29) and configured for reducing a pressure in the discharge element (20) at a downstream side (26) of the throttle element (25), for providing the cryogenic liquid (1) to flow from an upstream location (24) of the throttle element (25) through the throttle element (25), wherein at least part of the cryogenic liquid (1) changes phase at the downstream side (26) of the throttle element (25), if the discharge element inlet opening (21) and the first discharge element portion (23) are configured in the cryogenic liquid (1) and the further discharge element portion (29) protrudes from the cryogenic liquid (1).

10. The system (100) according to claim 9, comprising a container (10) for containing the cryogenic liquid (1), wherein the container (10) is an open container, wherein the container (10) contains the cryogenic liquid (1).

11. The system (100) according to claim 9, wherein the first discharge element portion (23) comprises one or more heat conductive extensions (22) extending from the heat conductive wall (28) for enhancing exchange of heat between the heat conductive wall (28) and external from the discharge element (20).

12. The system according to claim 9, wherein the throttle element (25) comprises one or more of a cavity, a porous element, a capillary tube, and a controllable flow restriction and/or wherein the discharge element inlet opening (21) comprises an orifice defining the throttle element (25).

13. The system (100) according to claim 9, wherein the pumping device (30) comprises a venturi vacuum system (35).

14. The system (100) according to claim 13, wherein the venturi vacuum system (35) is configured for a gaseous working fluid.

15. The system (100) according to claim 9, wherein the system further comprises a flare system (40) fluidically coupled a discharge of the discharge element (20).
